(19) United States
(12) Patent Application Publication
(10) Pub. No.: US 2026/0049796 A1
(43) Pub. Date: Feb. 19, 2026

(54) ELECTROSHOCK CIRCUIT DESIGN

(71) Applicant: Adnan ALBAYRAK, Fatih/Istanbul (TR)

(72) Inventor: Veysel EVRAN, Fatih/Istanbul (TR)

(21) Appl. No.: 19/101,727

(22) PCT Filed: Aug. 11, 2022
(86) PCT No.: PCT/TR2022/050844

§ 371 Date: Feb. 6, 2025

(51) Int. Cl. F41H 13/00

(52) U.S. Cl. CPC F41H 13/0012

(57) ABSTRACT

The invention relates to an electroshock circuit that provides both muscle locking and pain/ache formation, allowing shocking to be performed without the need for a certain distance.

### TECHNICAL FIELD OF THE INVENTION

The invention relates to an electroshock circuit that provides both muscle locking and pain/ache formation, allowing shocking to be performed without the need for a certain distance.

### STATE OF THE ART

Today, law enforcement officers often encounter great resistance when they want to detain people, they deem suspicious. Electroshock guns have been developed to break this resistance and to easily detain the suspect. When exposed to the electrical voltage from the stun gun, the muscles remain contracted and the person writhes since the brain and muscles constantly send commands.

In the state of the art, electroshock circuits are made in three different ways. The first one is generally DC constant voltage and low current circuits, in which the ends where the potential difference occurs are contacted contact the person over the skin. The operation of these circuits is only possible with external contact. The second is when one of the ends is inside the human skin and the other is outside. The way these circuits work is similar to those with direct contact. Thirdly, there are shock circuits in which ends with potential difference are applied inside the skin. In this case, both probes are in the skin. In these circuits, very high voltages are obtained and applied in a pulsed manner and with AC signals. The biggest difference of it from the contact shock circuits is that the pulsed signals cause muscle contraction, thus restricting the mobility.

The human body resistance varies from person to person and shows a non-linear change according to the acting voltage (such as 100V, 1000V). While the resistance of dry human skin can reach up to 100 k Ohm, wet and moist skin can decrease to 1 k. In addition, high voltage applied, and degraded skin can drop down to 500 Ohms.

In the table below, the internal resistance of the body against a current flowing between the two hands of a person for 50 Hz alternating current according to IEC standards is given. The percentile represents the proportion of the human population.

| | RESISTIVITY | | | |
|---|---|---|---|---|
| VOLTAGE | 5% | | 50% | 95% |
| 25 V | 1,750 | Ω | 3,250 Ω | 6.100 Ω |
| 100 V | 1,200 | Ω | 1,875 Ω | 3.200 Ω |
| 220 V | 1000 | Ω | 1.350 Ω | 2.125 Ω |
| 1000 V | 700 | Ω | 1,050 Ω | 1.500 Ω |

As can be understood from the explanations above, as well as the applied voltage, body humidity, and the distance measured on the body, human body resistance varies even from person to person. Even at short distances, there is a difference in resistance between fatty tissue and muscle tissue. For this reason, there is a need for a circuit design that enables shocking at low resistance values (such as 50-100 ohms).

The system mentioned in the document no “U.S. Ser. No. 10/989,503B2” in the state of the art is related to an electroshock system that provides wireless shock to a subject. The shock circuit was sent in a cap, and by this way, it was aimed to make a wireless shock weapon and neutralize the attacker from afar. The electroshock system includes a launcher, a wireless bullet, a power source, and a wireless power transmitter. The launcher is configured to be grasped by a user. The wireless power transmitter transmits power to the wireless bullet when it leaves the wireless bullet launcher. The power source and wireless transmitter may be co-located with the launcher or may be separate. One embodiment of the invention is towards a bullet that is configured to be fired from a launcher. A high value resistance is needed for the circuit described in said system to operate. High voltage is applied externally, and muscle locking cannot be achieved.

The system mentioned in the document no “US2006067026A1” in the state of the art is related to a stun gun with a shock area and more specifically developed effective range. A third arrow has been added to the stun guns, which normally use two arrows, to increase the range. The first barrel functions to hold it in the first position, while the second barrel functions to attach it to the receiver in a second position. Using the conductive body of the receiver, the first arrow and the second arrow help complete an electrical circuit. The first and second barrels are preferably made of a conductive metallic material. In an alternative embodiment of the invention, it is mentioned that the stun gun may contain a aimer that functions to assist aiming. The sight preferably includes a laser or a blade. However, alternatively, it is mentioned that it may include other suitable devices to assist in aiming the stun gun. In order to be able to shock effectively in said system, the distance to provide the necessary resistance over the body is needed.

The system mentioned in the document no “U.S. Ser. No. 10/598,467B1” is in the state of the art is related to stun gun with bullets. More specifically, it relates to a multi-shot stun gun capable of automatic and semi-automatic firing. By means of the double arrows connected in parallel to the shock circuit on the barrel, a second shot is allowed after one shot. The multi-shot stun gun is a double-barrel stun gun with a first barrel and a second barrel. The double-barrel stun gun contains at least one battery located inside the handle. The voltage booster circuit, on the other hand, can be mounted inside the long housing body of the stun gun. It is mentioned that the current wires that act as conductors in said system are copper wires covered with insulation. For an effective shocking, the distance to provide the necessary resistance on the body is needed. The shock circuit of said stun gun is located on the stun gun and is the only one. For this reason, if there is a distance difference between the attackers when two-shot shocks will be made, the remote attacker cannot be neutralized.

The disadvantage in the present system is that the circuit does not work if it cannot reach high load values in the outputs of the electroshock circuits, which are directly contacted and one of the probes of which is inside and the other outside. In this case, when the output loads are not limited, the circuits get damaged and burn. In addition, they do not provide muscle contraction and do not create a stopping effect. They are generally used to deter the attacker.

In applications where the two probes are in the skin, there is muscle contraction and the attacker is neutralized. These circuits are more advantageous than electroshock circuits that are directly contacted and one of the probes of which is inside and the other outside. However, it loses approximately 50 times the voltage produced during operation and its biggest disadvantage is that at least 30 cm distance is needed between the probes for it to work as desired in the body. Another disadvantage is that larger and more expensive components are needed to generate very high voltages.

As a result, due to the negativities described above and the inadequacy of the existing solutions on the subject, it was necessary to make an improvement in the relevant technical field.

### BRIEF DESCRIPTION AND AIMS OF THE INVENTION

The most important aim of the invention is to completely remove the structure that affects the designs of the stun guns and requires distance for effective shocking.

Another aim of the invention is to develop a system that can operate when the resistance is high or low.

Another aim of the invention is to provide both muscle stiffness and pain/ache formation with the electroshock circuit design.

### DESCRIPTION OF THE FIGURES

FIG. 1 is the drawing that gives the appearance of the electroshock circuit used in the current system.

FIG. 2 is the drawing that gives the appearance of an electroshock circuit that is the subject of the invention.

FIG. 3 is the drawing that gives the appearance of an electroshock circuit of the invention, created by adding a capacitor and a resistor.

FIG. 4 is the drawing that gives the appearance of the tube in the circuit of the invention.

### DEFINITION OF ELEMENTS/PARTS COMPOSING THE INVENTION

In order to better explain the electroshock circuit design developed with this invention, the parts and elements in the figures are numbered, and the equivalent of each number is given below:
1. High Voltage
2. Body
3. Tube
4. Capacitor
5. Resistor

### DETAILED DESCRIPTION OF THE INVENTION

The invention relates to an electroshock circuit that provides both muscle locking and pain/ache formation, allowing shocking to be performed without the need for a certain distance. In particular, the invention is an electroshock circuit design that can operate at higher voltages below 30 cm, in which the attacker can be neutralized by stimulating with pain and ache as well as muscle contraction. The developed system provides sufficient shocking and contraction even from a distance of 1 cm.

In the electroshock circuit design developed with the invention, both muscle locking and pain formation are provided, and there is no need for scattering.

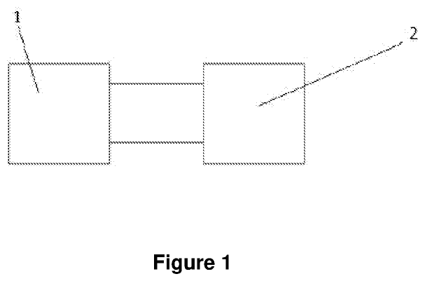

FIG. 1 shows the electroshock circuit design used in the current system. There is no tube (3) in this system. While there is no tube (3), the body resistance starts to decrease towards zero as soon as the voltage value on the capacitor starts to increase in DC signals. Since the output resistance will be almost zero before the voltage value rises, the voltage value also approximates to zero and no shocking effect occurs. This is also true for AC (pulsed) systems with two transformers. For this reason, a distance of at least 30 cm to the body is needed for these systems to work.

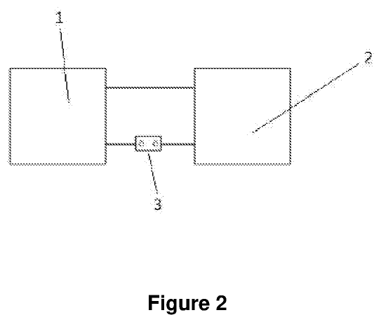

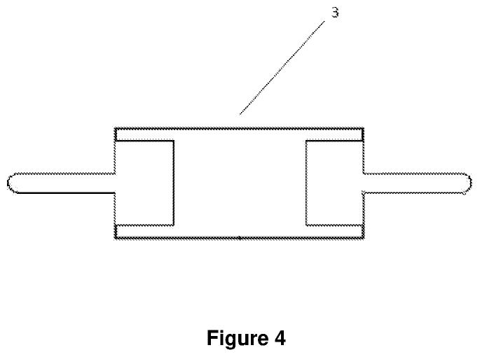

FIG. 2 shows the electronic circuit design developed with the invention. In this system, unlike the current system, a tube (3) is added to the circuit. The tube (3) has the structure indicated in FIG. 4. The two regions on the side denote the conductive parts, and the empty region in the middle denotes the space. Compressed gas or air is used in the space inside the tube (3) in the middle part. By this way, insulation is provided on the circuit and a stable system can be formed and operation can be provided in small systems in the desired voltage range.

The purpose of adding the tube (3) is to create an insulating zone at a certain rate. This region, which is insulating to a certain extent, is formed in such a way that it appears as an open circuit when the measurement is made from the two conductor ends of the tube (3) in the resistance stage. The purpose of creating an insulating zone is instantly to turns on direct conduction when high voltages are reached.

Depending on parameters such as temperature, pressure, humidity, etc. in the air, electrical refraction occurs at 1000V level from a distance of 1 mm. When the distance between the conductors in the tube (3) is 1 mm and the potential difference between the ends is 1000 V, electrical breakdown occurs. With electrical refraction or dielectric breakdown, some of the air is conducted and the circuit is completed. If the voltage is desired to be increased, the distance between the conductors in the tube (3) can be increased. In order to reach higher voltages without increasing the distance between the conductors in the tube (3), a gas with a higher dielectric constant than air can be used. Sulphur hexafluoride (SF6) gas is an example of this gas. This gas has a 2.5 times greater strength. When there is sulphur hexafluoride (SF6) gas in the tube (3), and in the case that the distance between the conductors in the tube (3) is 1 mm and the potential difference between the conductor ends is approximately 2500 V, electrical breakdown occurs and the circuit is completed. If the voltage is to be used as 5000 V, a tube filled with sulphur hexafluoride (SF6) gas with 2 mm intervals is used.

Sulphur hexafluoride (SF6) gas is an excellent dielectric gas for high voltage power applications. It is widely used by the power industry in high voltage circuit breakers and other switchgear.

In circuits where high voltage is produced, a capacitor is used to multiply and store the voltage after the transformer. In double transformer systems, capacitor and switching elements) are also used, this is also done over the capacitor. In the system developed with the invention, when the tube (3) is added, first the voltage and energy stored on the capacitor increase. When the insulation inside the tube (3) is defeated, it catches the high resistance on the body and shocks it. When the body resistance decreases, the shocking stops and the voltage on the capacitor increases again and shocking is re-performed. When the voltage is gone over the body (2), it turns into a high resistance state again. Using this structure of the body (2), shocking is done in a pulsed manner. With this pulsed shock, muscle contraction is ensured, preventing the use of muscles and neutralizing the attacker. Energy accumulates on the circuit until a voltage that can overcome the insulating region formed by the tube (3) arrives.

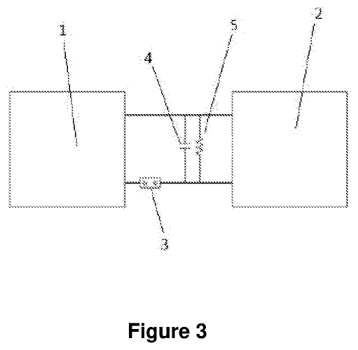

FIG. 3 shows the electroshock circuit design with capacitor (4) and resistor (5) added according to the intended use. Due to its nature, the capacitor (4) primarily stores the first incoming current as if there is a short circuit in the circuit. That is, when the capacitor (4) is added and the conduction starts by interrupting the insulation of the tube (3), the capacitor (4) stores energy and when the conduction is interrupted, it continues to deliver the stored energy for a while. Due to this feature of the capacitor (4), the time when the pulse is applied can be adjusted with the capacitor (4) at the output added to the circuit. When the pulse is applied, the capacitor (4) continues to deliver the energy it has stored after the circuit is interrupted.

With the resistor (5) added to the circuit according to the purpose of use, the operation of the circuit can be adjusted within the desired range and protection can be provided to the circuit. For example, if the internal resistance of the circuit is 500 ohms (working inside the body), 50000 resistance can be placed. If the body resistance is 50000 ohms (direct contact mode operation), a 3 megohm resistor can be used. When specified as a range, this value is greater than 10000 ohms and less than 1 gigaohm. The resistor (5) also provides a resistance value between 10000 ohms and 50000 ohms in case the circuit is only desired to be used inside the body (2).

In the case where the arrows are not stuck in said circuit (in the case of an open circuit), the high voltage can multiply and damage the elements before it. In order to prevent this situation, discharge is provided over the selected resistance value. Adjusting the working range is determined according to the desired working style. If it is desired to work only inside the body (2), a lower resistance value can be used. By selecting the resistance value of 50-100 times the selected resistance value, both safety and operating range are determined. For example, when the internal resistance of the body is 500 ohm and the resistance value of 50 k is selected, the current completes itself from 500 ohms, which is the easy way, i.e., from the human body.

By means of the circuit developed with the invention, it is possible to make a stun gun with a touch mode, with cable or in bullet shape. The body resistances of the three models mentioned are different from each other. For this reason, as mentioned above, the operating range should be determined before determining the resistance value. If it is thought that the arrows are not stuck, the circuit will be an open circuit and the voltage on the components will increase and burn the circuit. The circuit is protected by providing discharge with the placed resistance (50 k). However, it does not work in this way with touch mode.

A higher resistance value is used to ensure that one of the arrows is fully inserted and the other is not fully inserted, so that it remains within the desired operation. The expression that reads “if one of the arrows is stuck and the other is not fully stuck” is related to the output resistance. For example, if the output resistance is 500 ohms when the arrows are fully stuck, this value can be 50 k ohms when one of the arrows is not stuck.

With the circuit developed by the invention, a design that can lock muscles even at a distance of 1 cm has been achieved.

It is an electroshock circuit in which the muscle is neutralized for the duration of the action by applying a pulsed signal, unlike the contact stun guns.

The developed shock circuit design occupies less space than half of the standard shock circuits. For this reason, by placing two different shock circuits inside the stun gun, both attackers can be neutralized easily, regardless of distance.

1. An electroshock circuit in which shocking is performed without the need for a certain distance and both muscle locking and pain/ache formation are provided, comprising:
a tube (3) ensuring that an insulating zone is formed enough to make it appear as an open circuit when the measurement is made from both ends of the measuring instrument and the resistance stage and that the voltage and energy stored on the capacitor are increased, having two conductive regions on its sides and an empty region in the middle, enabling that the high resistance on the body (2) is caught and the shocking process is made when the insulation inside is overcome, and providing pulse shocking by increasing the voltage on the capacitor by stopping the shocking process when the body resistance decreases.

2. The electroshock circuit according to claim 1, comprising the tube (3) that contains air in the empty area between the conductive parts on its sides to provide an insulating zone.

3. The electroshock circuit according to claim 1, comprising the tube (3) containing sulphur hexafluoride gas in the empty space between the conductive part on its sides, to ensure that the distance between the conductive ends is between 1 mm and 2 mm and the potential difference between the conductive ends is between 2500 V and 5000 V.

4. The electroshock circuit according to claim 1, comprising the capacitor (4), which ensures that the first current that comes into the circuit is stored in itself, and that the stored energy continues to be provided after the circuit is interrupted.

5. The electroshock circuit according to claim 1, comprising the resistor (5) that allows the resistance value to be adjusted between 1 giga-ohm and 10000 ohms to enable working inside or outside the body.

6. The electroshock circuit according to claim 1, comprising the resistor (5) that protects the circuit.

7. The electroshock circuit according to claim 1, comprising the resistor (5) providing a resistance value between 10000 ohms and 50000 ohms, only in case of use inside the body (2).
